(19) United States
(12) Patent Application Publication
(10) Pub. No.: US 2025/0306328 A1
(43) Pub. Date: Oct. 2, 2025

(54) CABLE ARMOR REMOVAL TOOL

(71) Applicant: TRAXyL, Inc., GAINESVILLE, VA (US)

(72) Inventors: Daniel R. Turner, Chantilly, VA (US); Daniel Philip Garbus, Sterling, VA (US); Alexander Rodriguez, Strasburg, VA (US)

(21) Appl. No.: 19/089,592

(22) Filed: Mar. 25, 2025

Related U.S. Application Data
(60) Provisional application No. 63/569,874, filed on Mar. 26, 2024.

(51) Int. Cl. G02B 6/46; G02B 6/245; G02B 6/44

(52) U.S. Cl. CPC G02B 6/566; G02B 6/245; G02B 6/443

(57) ABSTRACT

The subject matter of this specification can be embodied in, among other things, a method that includes receiving the cable assembly that includes a cable core assembly coaxially surrounded by a protective helical coil between a first cable end and a second cable end, defining a severed section of protective helical coil away from the first cable end and the second cable end and is separately revolvable about the cable core assembly apart from remainders of the protective helical coil, inserting a separator apparatus between the cable core assembly and the protective helical coil, expanding, by the separator apparatus, the protective helical coil away from the cable core assembly, and separating the protective helical coil from the cable core assembly.

### CROSS-REFERENCE TO RELATED APPLICATIONS

This application claims the benefit of priority to U.S. Provisional Application No. 63/569,874, filed on Mar. 26, 2024, the contents of which are hereby incorporated by reference.

### TECHNICAL FIELD

This instant specification relates to a tool configured to strip armored fiber optic cables.

### BACKGROUND

Armored fiber optic cables are designed for use in harsh environments where they may be exposed to physical damage, moisture, or extreme temperatures. They are commonly used in underground installations, underwater installations, aerial installations, and a newer surface-mounted and surface-embedded techniques, and in both indoor and outdoor applications.

### SUMMARY

In general, this document describes a tool configured to strip away the armor of armored fiber optic cables.

The systems and techniques described here may provide one or more of the following advantages. First, a system can remove armor layers at midsections or midspans of armored fiber optic cables. Second, the system can protect the underlying layers and fiber optic strands during the armor removal process. Third, the system can speed the deployment of fiber optical communication networks by reducing the amount of time needed to expose individual optical fibers that can be spliced to optical fibers in communication with optical end devices (e.g., the “last mile”). Fourth, the system can the speed the deployment and reduce the installation cost of fiber optical communication networks by reducing the risk and occurrence of damage to fiber optic strands and the subsequent need for field diagnosis and repair of damaged optical fibers. Fifth, the system can reduce the number of splices required for a Fiber to the Home (FTTH), Fiber to the Premises (FTTP), or Fiber to the X (FTTX) type of deployment by reducing or eliminating the need to cut and splice all fibers in the cable. This can enable a splicing technician to choose which fibers need to be accessed and spliced, leaving the rest of the fibers intact. Ultimately, this can reduce the splicing time and cost, and can also reduce the number of splices in a link, thereby reducing or minimizing the optical loss along a link. Less overall optical loss can allow fiber links to go further and can also increase the probability to maintain a connection if there is a greater amount of loss at a certain area along an optical fiber path, e.g., the link can still close because other splice enclosure areas have reduced or minimized the optical loss by not requiring every fiber to need a splice.

The details of one or more implementations are set forth in the accompanying drawings and the description below. Other features and advantages will be apparent from the description and drawings, and from the claims.

### DESCRIPTION OF DRAWINGS

FIG. 1 is a cross-sectional view of an armored fiber optic cable assembly.

FIGS. 2A-2E are various side views of a separator apparatus.

FIG. 3 is a perspective view of a separator tool, a protective helical coil, and cable core assembly.

FIG. 4 shows several examples of separator apparatuses.

FIG. 5 shows the separator apparatus affixed to an example fixture.

FIG. 6 shows another example of a fixture.

FIGS. 7A and 7B show an example of another separator apparatus.

FIG. 8 is flow chart that shows an example of a process for stripping a protective helical coil from an armored cable assembly.

FIGS. 9-18 show various examples of steps for stripping a protective helical coil from an armored cable assembly.

### DETAILED DESCRIPTION

This document describes systems and techniques for stripping a protective helical coil from an armored cable assembly. In general, a section of armor is severed at two locations along a midpoint of an armored cable. A tool resembling a hypodermic needle is used to at least partly surround the fragile core and slip between the core and the protective helical coil. The tool helps to expand the protective helical coil and protect the core from damage (e.g., accidental cuts, wear/rubbing, heat from friction) as the protective helical coil is uncoiled from the core.

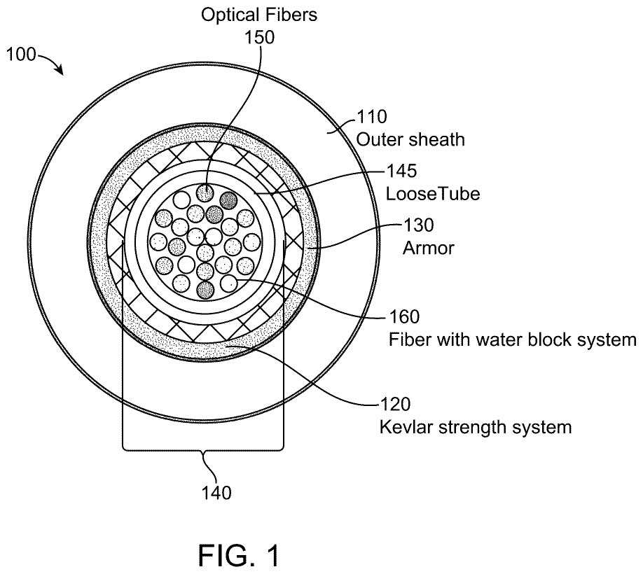

FIG. 1 is a cross-sectional view of an example armored cable assembly 100. The armored cable assembly 100 includes several layers that protect a fragile fiber optic core. The outermost layer is an outer sheath 110 that protects the cable from sun exposure and damage from ultraviolet light. It also protects the cable while being unspooled and handled. Beneath the outer sheath 110 is a strength layer 120 configured to provide tensile strength and prevent the armored cable assembly 100 from being pulled apart. In some embodiments, the strength layer 120 can be made from aramid fibers or yarns (e.g., forming a KEVLAR jacket). Beneath the strength layer is a protective helical coil 130 that provides strength and crush resistance. In some embodiments, the protective helical coil 130 can be a helical coil of stainless steel armor. Inside the protective helical coil 130, a cable core assembly 140 includes a loose tube 145 and a collection of optical fibers 150 within the loose tube 145. In some embodiments, each of the optical fibers 160 can has its own individual jacket to separate the fibers from each other and provides some protection from external pressure. In some embodiments, each of the optical fibers 160 can have a water blocking system to prevent moisture ingress. In some embodiments, the loose tube 145 and cable core assembly 140 are one in the same. The armored cable assembly 100 extends between a first cable end (not shown) and a second cable end (not shown).

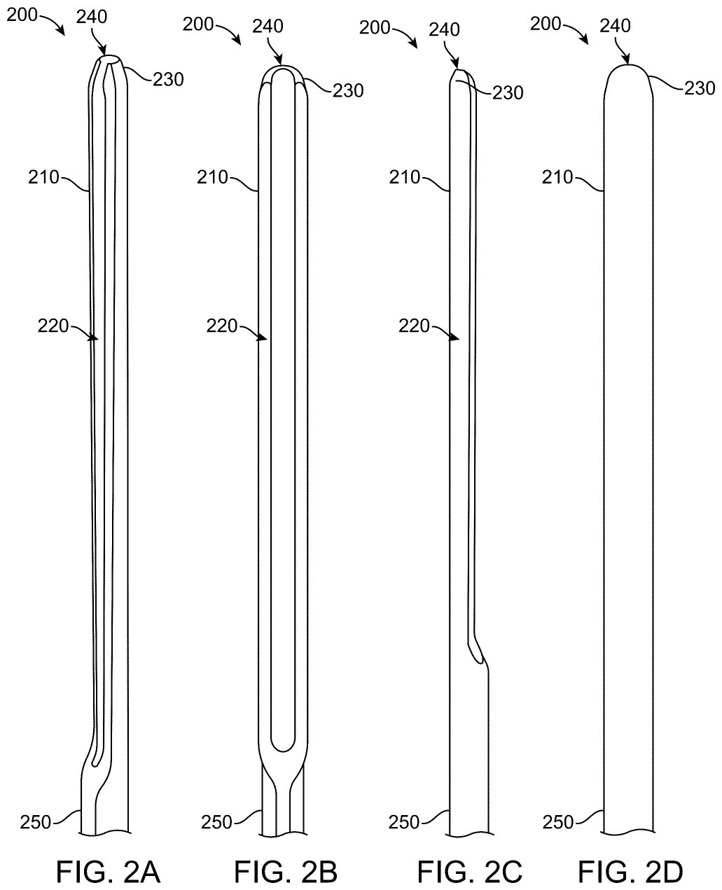

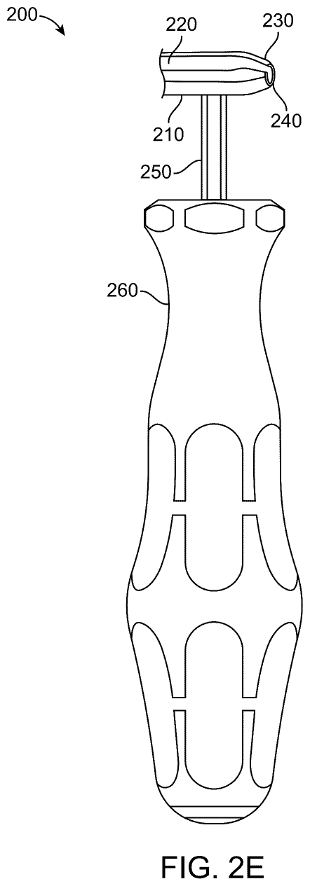

FIGS. 2A-2E are various side views of an example separator apparatus 200. The separator apparatus 200 has a semi-cylindrical housing 210. The semi-cylindrical housing 210 defines a lengthwise cavity 220. A tapered tip 230 partly defines an end of the semi-cylindrical housing 210. The lengthwise cavity 220 extends through the tapered tip 230. The lengthwise cavity 220 is substantially C-shaped in cross-section, and the tapered tip 230 defines a C-shaped opening 240 to the lengthwise cavity 220. The lengthwise cavity 220 need only extend long enough to spirally remove the armor helix. A shank 250 of the lengthwise cavity 220 is rigid and adds strength to the tool and adds a place to hold onto the semi-cylindrical housing 210 or connect the semi-cylindrical housing 210 to a handle 260. In some embodiments, the shank 250 can extend away from the semi-cylindrical housing 210 in both a parallel direction or perpendicular direction.

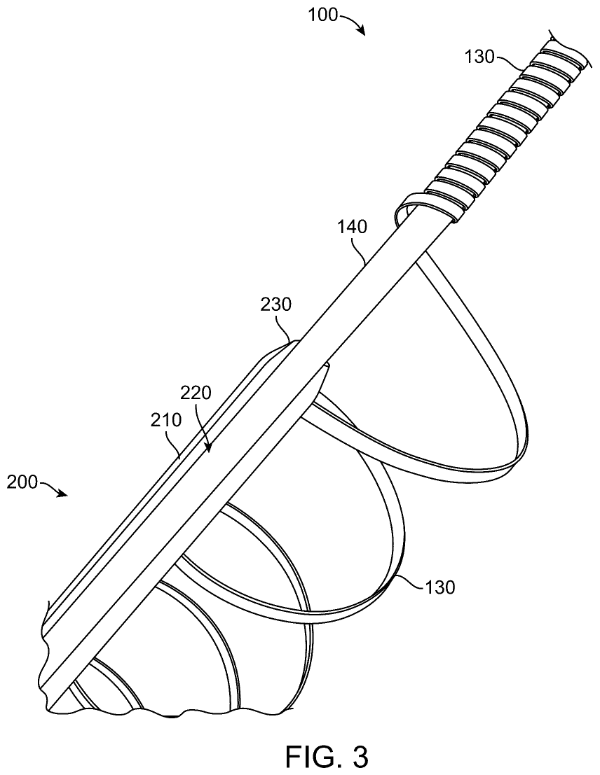

FIG. 3 is a perspective view of the example separator apparatus 200 of FIGS. 2A-2E, and the example protective helical coil 130 and the example cable core assembly 140 of the armored cable assembly 100 of FIG. 1. In the illustrated example, a lengthwise section of the armored cable assembly 100 has been stripped of the outer sheath and the strength layer 120

The lengthwise cavity 220 of the separator apparatus 200 has a diameter that is complimentary to (e.g., substantially equal to or greater than, having a similar cross-sectional shape) a predetermined diameter of the cable core assembly 140 of the armored cable assembly 100. The tapered tip 230 is a semicircular tip partly defining an end of the lengthwise cavity 220, and the semicircular tip has a diameter equal to or smaller than a predetermined diameter of the protective helical coil 130 and has a diameter equal to or larger than the predetermined diameter of the cable core assembly 140.

In use, an exposed section of cable core assembly 140 is arranged within the lengthwise cavity 220, such that the semi-cylindrical housing 210 at least partly surrounds a portion of the cable core assembly 140. The protective helical coil 130 is abutted to the tapered tip 230 (or the tapered tip 230 is abutted to the protective helical coil 130), such that the separator apparatus 200 separates or spaces apart the protective helical coil 130 from the cable core assembly 140, or otherwise becomes partly coaxially interposed between the protective helical coil 130 and the cable core assembly 140.

The separator apparatus 200 protects the cable core assembly 140 while the protective helical coil 130 is removed. For example, and end of the protective helical coil 130 can be gripped and pulled substantially away from the cable core assembly 140. During this process, the protective helical coil 130 can be caused to rub against the separator apparatus 200 instead of the cable core assembly 140, reducing abrasive wear on the cable core assembly 140. In another example, the protective helical coil 130 can heat up during removal (e.g., due to bending of the metal, due to friction), and the separator apparatus 200 can reduce the amount of potentially damaging heat that is transferred to the cable core assembly 140 (e.g., the separator apparatus 200 can act as a thermal insulator or heat sink, the separator apparatus 200 can define an air gap between the protective helical coil 130 and the cable core assembly 140.

In some implementations, to facilitate removal of the protective helical coil 130, the protective helical coil 130 can be severed and a free end of the severed coil can be gripped with a gripper (e.g., a pliers or purpose-made apparatus) and pulled tangentially away from the cable core assembly 140. In some implementations, the free end of the severed coil can be removably affixed to a rotatable spool apparatus (e.g., an accessory for a power drill) that can be rotated to uncoil the protective helical coil 130 and re-coil the protective helical coil 130 about the spool.

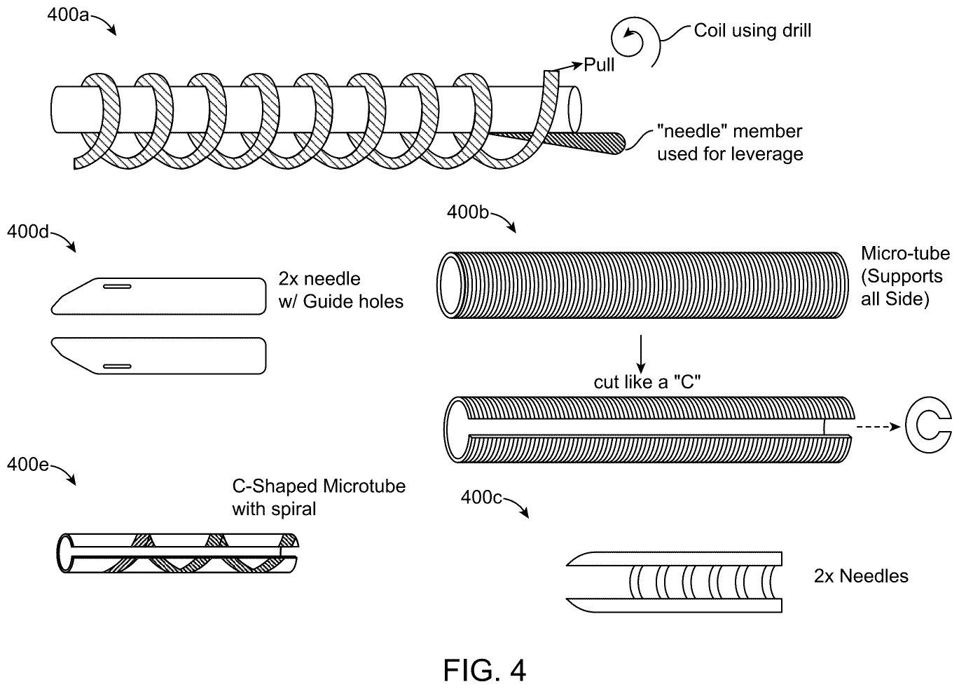

FIG. 4 shows several examples of separator apparatuses. An example separator apparatus 400a has a needle-like structure that is inserted between a cable core assembly and a protective helical coil to provide leverage to separate the protective helical coil from the cable core assembly.

An example separator apparatus 400b is formed as a tube with a lengthwise cut in its side wall (e.g., a semi-cylindrical tube with a c-shaped cross section).

An example separator apparatus 400c is formed as two or more needles or lengthwise cylindrical sections positioned relative to each other by one or more supports.

An example separator apparatus 400d is formed as two or more needles. One or more of the needles includes a guide aperture defined therethrough. In use, a severed end of a protective helical coil is inserted through the guide aperture to draw the protective helical coil away from cable core assembly and/or urge the protective helical coil away from cable core assembly at a predetermined angle.

An example separator apparatus 400e is formed as a helical spiral defining a helical gap between adjacent coils of the helix. In use, an exposed portion of the cable core assembly is inserted into the helical gap, and the helical spiral is at least partly wound around the cable core assembly. The separator apparatus 400e is caused to become interspersed between the cable core assembly and the protective helical coil as the protective helical coil is drawn away from the cable core assembly.

In another example, a separator apparatus can include two coaxial, semi-cylindrical housing portions that are both substantially c-shaped in cross section and have a longitudinal aperture that permits lateral access to a longitudinal cavity. In use, an outer semi-cylindrical housing portion can be rotated to align the outer longitudinal aperture with the inner longitudinal aperture. The cable core assembly can be inserted into the longitudinal cavity of the inner semi-cylindrical housing portion, and then the outer semi-cylindrical housing portion can be axially revolved about the inner semi-cylindrical housing portion to close the inner longitudinal aperture and cause the cable core assembly to be substantially surrounded and protect the cable core assembly on substantially all lateral sides.

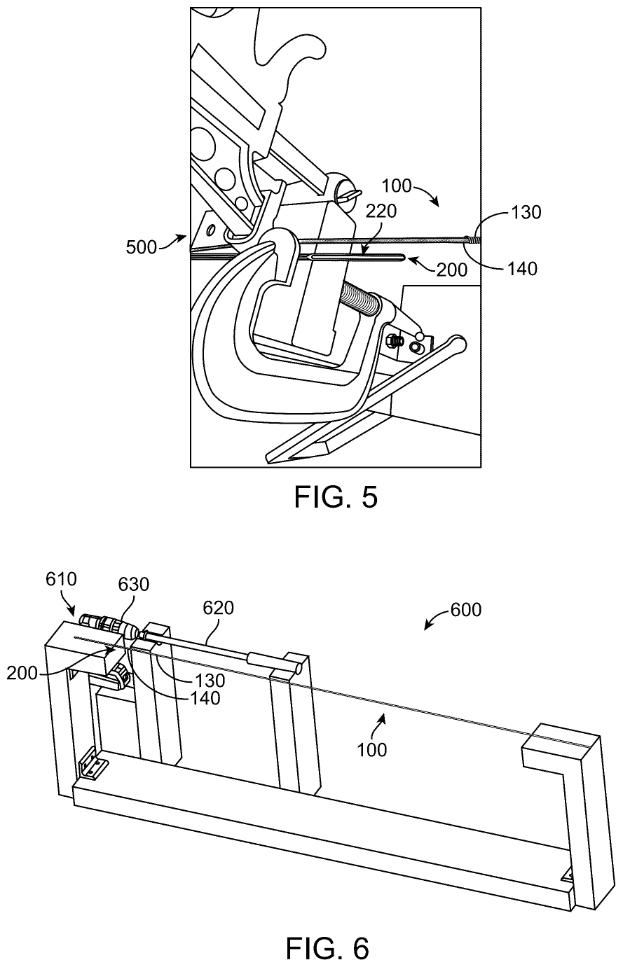

FIG. 5 shows the separator apparatus 200 affixed to an example fixture 500. In the illustrated embodiment, the separator apparatus 200 is removably affixed (e.g., by a clamp) to the shank 250 to fix the orientation of separator apparatus 200 and hold it steady from lateral and rotational movement as the cable core assembly 140 is arranged within the lengthwise cavity 220 and the protective helical coil 130 is drawn into contact with the separator apparatus 200.

FIG. 6 shows another example of a fixture 600. The separator apparatus 200 is removably affixed at the shank 250 to the fixture 600 to immobilize the separator apparatus 200 and hold it steady from lateral and rotational movement as the cable core assembly 140 is arranged within the lengthwise cavity 220 and the protective helical coil 130 is drawn into contact with the separator apparatus 200.

The fixture 600 also includes a removal apparatus 610 configured to rotate a spool 620. The fixture 600 is configured to support the spool 620 in a predetermined position away from the separator apparatus 200. The spool 620 is rotated to draw the protective helical coil 130 away from the cable core assembly 140 and become re-wound about the spool 620.

In the illustrated example, the spool 620 is configured to be rotated by a portable drill 630. In some embodiments, the fixture can include a motor configured to rotate the spool 620. In some embodiments, the fixture can include a crank or wheel configured to rotate the spool 620 based on manual other any other appropriate form of rotational input.

In some implementations, the fixture 600 can be moved along the cable core assembly 140 as the protective helical coil 130 is removed. For example, the cable core assembly 140 and the protective helical coil 130 can be part of an exposed section of the armored cable assembly 100 after the armored cable assembly 100 has already been installed in the field and is not easily removed.

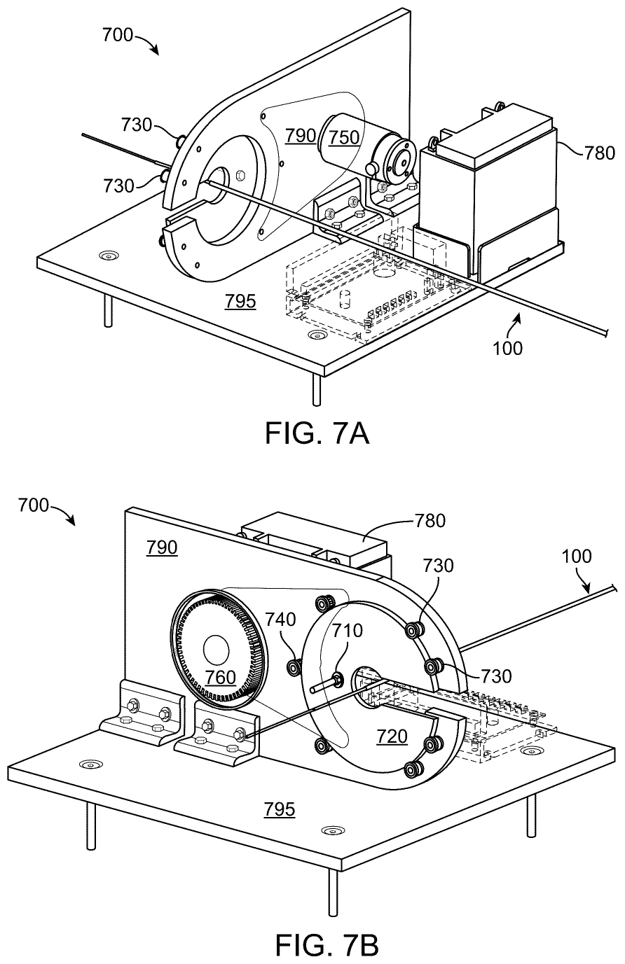

FIGS. 7A and 7B show an example of another separator apparatus 700. The unwinding of the protective helical coil 130 or other similar armor is similar to the operation of a tape wrapping machine, but in the opposite direction. The severed armor end is secured to a spool 710. A C-shaped spinner 720 is captured and secured by a collection of free rollers 730 and a collection of gear rollers 740. The C-Shaped spinner 720 is rotated about the cable by a motor 750, a gear 760, and a belt 770 (not shown). The motor 750 spins by a power source 780. The motor 750, the gear 760, the collection of free rollers 730, the collection of gear rollers 740, and the spool 710 are all mounted to a frame 790. The frame 790 is mounted to a base 795. The rotation is opposite of the direction that the protective helical coil 130 is wound onto the cable core assembly 140, and the protective helical coil 130 is essentially unwound from the cable core assembly 140.

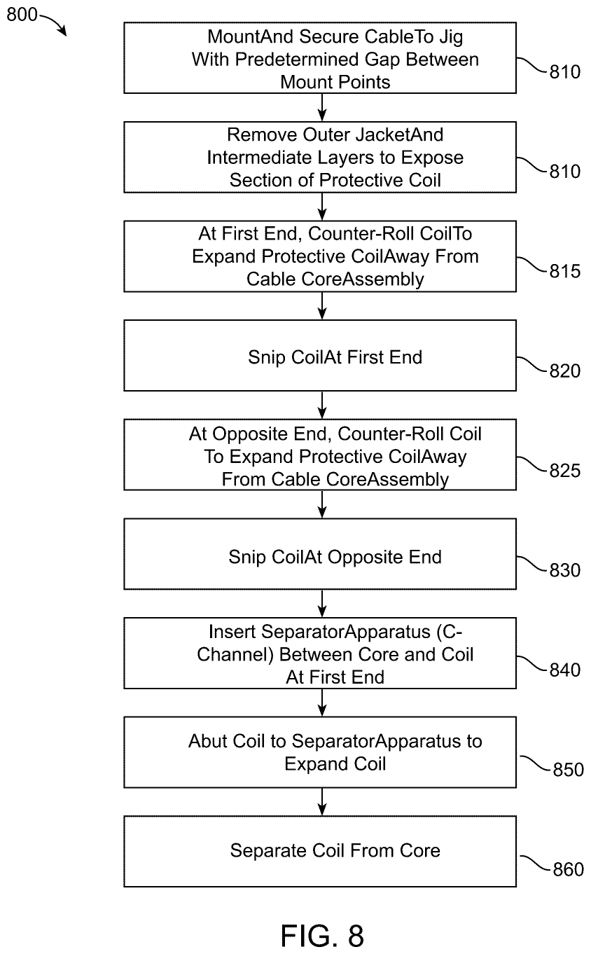

FIG. 8 is flow chart that shows an example of a process 800 for stripping a protective helical coil from an armored cable assembly. The process 800 may be performed, for example, by an apparatus such as the separator apparatus 200. However, another system, or combination of systems, may be used to perform the processes.

At 805, the cable assembly is received and mounted to a jig. The cable assembly includes a cable core assembly coaxially surrounded by a protective helical coil between a first cable end and a second cable end. For example, the example armored cable assembly 100, which extends between two distal ends, can be received or located by a technician. The armored cable assembly 100 can be mounted to the example fixture 500 or 600.

In some embodiments, the cable core assembly can include one or more optical fibers. For example, the armored cable assembly 100 can include the optical fibers 160.

At 810, an outer jacket and intermediate layers are removed to expose a section of protective helical coil. For example, a lengthwise section of the outer sheath 110 and the strength layer 120 can be removed to expose a section of the protective helical coil 130.

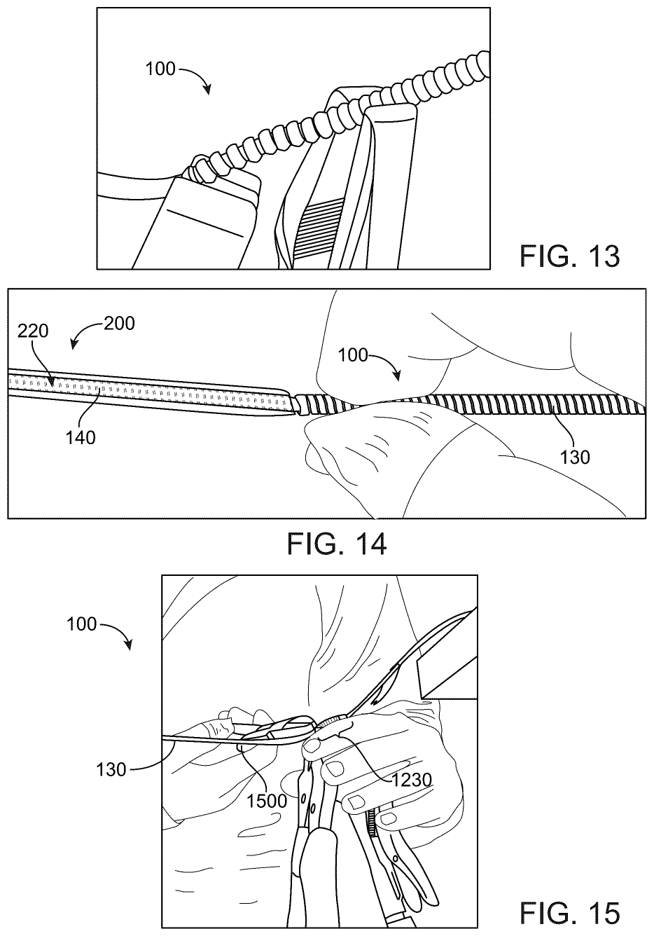

At 815, the protective helical coil is counter-rolled to expand the protective helical coil away from the cable core assembly. For example, FIG. 12 shows an example in which a protective helical coil is gripped at a first location 1210 by a clamping pliers 1220 and is gripped by another clamping pliers 1222 at a second location 1212 a short distance (e.g., about a quarter inch or half inch) away from the first location. The clamping pliers 1220 is revolved about the protective helical coil 130 in a second direction opposite the first direction, in a direction counter to the armor winding, to expand, by the revolving, the protective helical coil 130. For example, FIGS. 13 and 15 show that the helix of the protective helical coil 130 has be partly counter-wound, which expands the diameter of the helix, moving the coils away from the cable core assembly 140 and separating the coils from each other, making it easier for a technician to access and sever (e.g., snip with a cutting tool 1500 such as a wire cutter) one or more coils of the expanded section 1230, without damaging the underlying tube and fibers. This process can be repeated at the second predetermined lengthwise location 1204 along the protective helical coil 130 to define a section of the protective helical coil along a midspan of the armored cable assembly 100 and is at least partly rotatable and/or longitudinally moveable relative to the remaining portions of the protective helical coil 130.

At 820 to 830, a severed section 1200 (see FIG. 12) of protective helical coil 130 is defined away from the first cable end and the second cable end and is separately revolvable about the cable core assembly 140 apart from remainders of the protective helical coil 130. The severed section 1200 is defined by counter-rolling and expanding the protective helical coil 130 at a second predetermined lengthwise location 1204 along the armored cable assembly 100, different from the first lengthwise location 1202, and severing the protective helical coil 130 at the second predetermined lengthwise location 1204.

The severing of the protective helical coil at the first lengthwise location and/or the second lengthwise location can include gripping, by a first gripper, the protective helical coil at a first grip location, in which the protective helical coil is wound in a first direction, gripping, by a second gripper, the protective helical coil at a second grip location away from the first grip location, and preventing, by the second gripper, revolution of the protective helical coil in the second direction urged by the revolving.

In some implementations, after making a single snip of the armor, a technician could manually unwind a predetermined length of armor from the rest of the cable using clamping pliers or similar gripping tools. However, use of the separator apparatus 200 can enable faster and safer armor removal.

At 840, a separator apparatus is inserted between the cable core assembly and the protective helical coil. In some embodiments, the separator apparatus can include a semi-cylindrical housing defining a cavity and a tapered longitudinal end having a semicircular tip partly defining an end of the cavity, where the cavity is complimentary to a predetermined diameter of the cable core assembly and the semicircular tip has a diameter equal to or smaller than a diameter of the protective helical coil and has a diameter equal to or larger than the predetermined diameter of the cable core assembly. For example, the separator apparatus can be the example separator apparatus 200 of FIGS. 2A-2D. FIG. 14 shows an example in which the cable core assembly 140 is inserted into the lengthwise cavity 220 of the separator apparatus 200 and extends at least partly between the cable core assembly 140 and the protective helical coil 130.

At 850 the separator apparatus is used to expand the protective helical coil away from the cable core assembly. For example, FIG. 14 shows that the helix of the protective helical coil 130 has been partly expanded away from the cable core assembly 140.

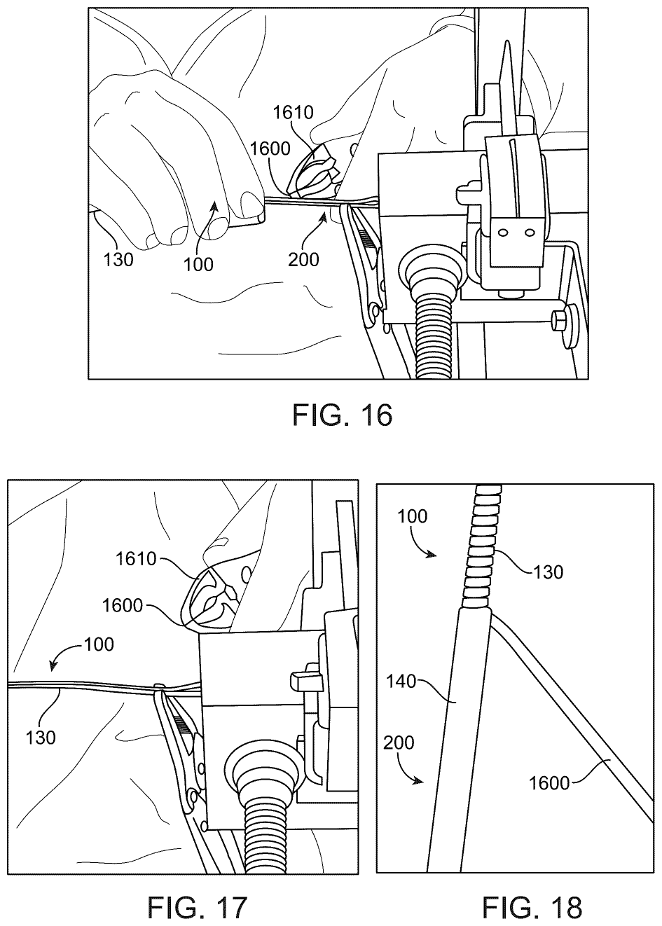

At 860, the protective helical coil is separated from the cable core assembly. For example, FIG. 16 shows that a severed end 1600 of the protective helical coil 130 can be gripped with a gripper 1610 (e.g., a locking pliers). FIG. 16 shows the gripper 1610 being used to pull the severed end 1600 away from the cable core assembly 140.

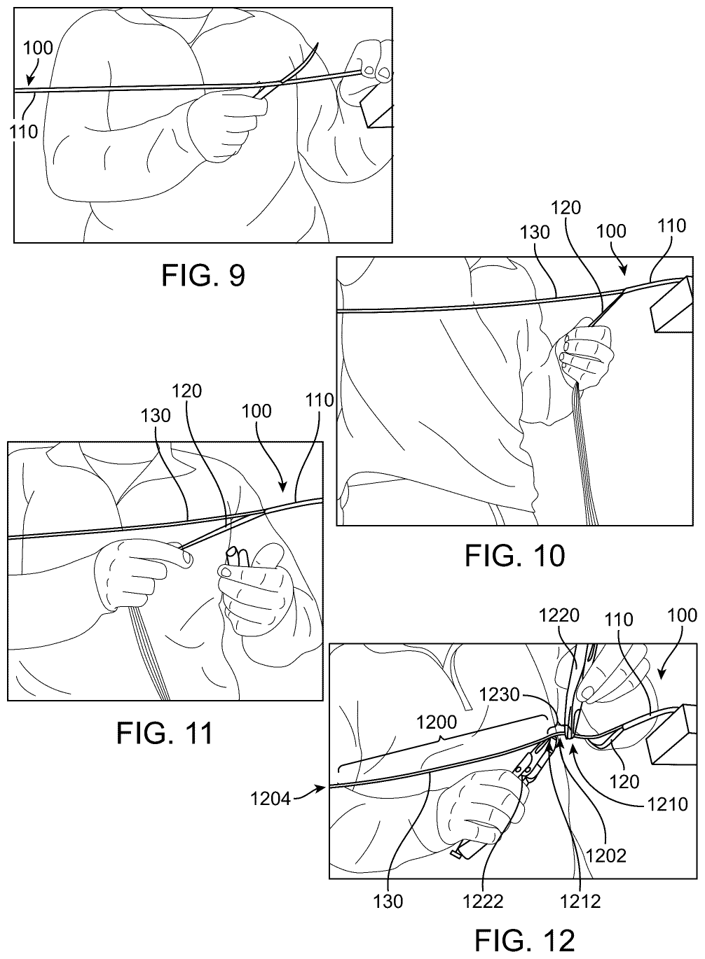

In some implementations, the process 800 can include removing an outer jacket coaxially surrounding the protective coil, wherein the cable assembly further comprises the outer jacket. For example, FIGS. 9-11 show that a section of the outer sheath 110 and the strength layer 120 can be removed from the armored cable assembly 100 to expose a section of the protective helical coil 130.

In some implementations, the process 800 can include abutting a first end of the separator apparatus to the protective helical coil. For example, the severed section 1200 of the protective helical coil 130 can be urged to slide along the cable core assembly 140 by pulling the severed end of the coil at a diagonal vector both toward the separator apparatus 200 to abut the protective helical coil 130 against the separator apparatus 200, and downward to urge the protective helical coil away from the core. In another example, the severed section 1200 of the protective helical coil 130 can be substantially held in place while the separator apparatus 200 is moved along the cable core assembly 140 to bring the separator apparatus 200 into abutment with and end of the severed section 1200, while pulling the severed section downward to urge the protective helical coil away from the core.

In some implementations, the process 800 can include revolving the severed section about the cable core assembly and uncoiling the protective helical coil by drawing a severed end of the protective helical coil away from the cable core assembly. For example, as the gripper 1610 pulls the severed end 1600 away from the cable core assembly 140, the severed section 1200 of the protective helical coil 130 is urged to unwind and rotate about the cable core assembly 140, while also drawing the remainder of the helical coil towards the separator apparatus 200.

In some implementations, the shank 250 might be clamped or secured to some fixture 500 similar to FIG. 5, or the shank 250 might be mounted to a handle 260 similar to what is shown in FIG. 2E.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method for stripping a cable assembly, comprising:
receiving the cable assembly, wherein the cable assembly comprises a cable core assembly coaxially surrounded by a protective helical coil between a first cable end and a second cable end;
defining a severed section of protective helical coil away from the first cable end and the second cable end and is separately revolvable about the cable core assembly apart from remainders of the protective helical coil;
inserting a separator apparatus between the cable core assembly and the protective helical coil;
expanding, by the separator apparatus, the protective helical coil away from the cable core assembly; and
separating the protective helical coil from the cable core assembly.

2. The method of claim 1, wherein the cable core assembly comprises one or more optical fibers.

3. The method of claim 1, wherein defining the severed section further comprises:
severing the protective helical coil a first lengthwise location along the cable assembly; and
severing the protective helical coil a second lengthwise location along the cable assembly, different from the first lengthwise location.

4. The method of claim 1, further comprising removing an outer jacket coaxially surrounding the protective helical coil, wherein the cable assembly further comprises the outer jacket.

5. The method of claim 1, further comprising:
gripping, by a first gripper, the protective helical coil at a first grip location, wherein the protective helical coil is wound in a first direction;
revolving the first gripper about the protective helical coil in a second direction opposite the first direction; and
expanding, by revolving, the protective helical coil.

6. The method of claim 5, further comprising:
gripping, by a second gripper, the protective helical coil at a second grip location away from the first grip location; and
preventing, by the second gripper, revolution of the protective helical coil in the second direction urged by the revolving.

7. The method of claim 1, further comprising abutting a first end of the separator apparatus to the protective helical coil.

8. The method of claim 1, further comprising:
revolving the severed section about the cable core assembly; and
uncoiling the protective helical coil by drawing a severed end of the protective helical coil away from the cable core assembly.

9. The method of claim 1, wherein the separator apparatus comprises a semi-cylindrical housing defining a cavity and a tapered longitudinal end having a semicircular tip partly defining an end of the cavity, wherein the cavity is complimentary to a predetermined diameter of the cable core assembly and the semicircular tip has a diameter equal to or smaller than a diameter of the protective helical coil and has a diameter equal to or larger than the predetermined diameter of the cable core assembly.

10. The method of claim 1, further comprising severing a portion of the severed section.

11. A separator apparatus comprising:
a semi-cylindrical housing:
a lengthwise cavity partly defined by the semi-cylindrical housing; and
a tapered tip partly defining an end of the semi-cylindrical housing, wherein the lengthwise cavity extends therethrough.

12. The separator apparatus of claim 11, wherein the lengthwise cavity has a diameter complimentary to a predetermined diameter of a cable core assembly of a predetermined cable assembly.

13. The separator apparatus of claim 12, wherein the end has a semicircular tip partly defining an end of the lengthwise cavity and the semicircular tip has a diameter equal to or smaller than a predetermined diameter of a protective helical coil of a predetermined cable assembly and has a diameter equal to or larger than the predetermined diameter of the cable core assembly.

14. The separator apparatus of claim 11, wherein the semi-cylindrical housing is substantially C-shaped in cross-section.

15. The separator apparatus of claim 11, wherein the semi-cylindrical housing comprises:
a first semi-cylindrical housing portion; and
a second semi-cylindrical housing portion arranged semi-coaxially about the first semi-cylindrical housing portion and configured to at least partly revolve about the first semi-cylindrical housing portion.

16. The separator apparatus of claim 11, wherein the semi-cylindrical housing is defined as a helical spiral.

17. The separator apparatus of claim 11, further comprising a fixture configured to removably retain the semi-cylindrical housing and substantially fix an orientation of the semi-cylindrical housing relative to the fixture.

18. The separator apparatus of claim 11, further comprising a gripper configured to releasably grip a severed end of a protective helical coil of a cable assembly.

19. The separator apparatus of claim 18, further comprising a spool configured to receive a severed end of a protective helical coil of a cable assembly and rotate to uncoil the protective helical coil.

20. The separator apparatus of claim 11, further comprising a cutter configured to sever a protective helical coil of a cable assembly.
